(19) United States
(12) Patent Application Publication
(10) Pub. No.: US 2018/0101294 A1
(43) Pub. Date: Apr. 12, 2018

(54) INFORMATION GENERATING SYSTEM, INFORMATION GENERATING DEVICE, INFORMATION GENERATING METHOD, AND INFORMATION GENERATING PROGRAM

(71) Applicant: Kabushiki Kaisha Toshiba, Minato-ku (JP)

(72) Inventors: Akira Kuroda, Yokohama (JP); Hidenori Matsuzaki, Fuchu (JP); Xinxiao Li, Yokohama (JP); Mayuko Koezuka, Ota (JP); Nobuaki Tojo, Yokohama (JP)

(73) Assignee: Kabushiki Kaisha Toshiba, Minato-ku (JP)

(21) Appl. No.: 15/677,166

(22) Filed: Aug. 15, 2017

(30) Foreign Application Priority Data
Oct. 6, 2016 (JP) 2016-198406

(51) Int. Cl. G06F 3/0484; G06F 11/36

(52) U.S. Cl. CPC G06F 3/04847; G06F 11/3688

(57) ABSTRACT

An information generating system generating display information representing setting conditions at the time of executing a target module outputting a processing result according to the setting conditions, the system comprises a receiver receiving the setting conditions selected by a user; and a generator generating the display information for generating a display image, wherein one or more setting condition axes representing the setting conditions are displayed on the display image, first value objects representing specific values of the setting conditions received in the receiver are displayed on the setting condition axes, and a relational object representing a correspondence relationship is displayed between the first value objects.

### CROSS-REFERENCE TO RELATED APPLICATIONS

This application is based upon and claims the benefit of priority from Japanese Patent Application No. 2016-198406, filed on Oct. 6, 2016; the entire contents of which are incorporated herein by reference.

### FIELD

Embodiments of the present invention relates to an information generating system, an information generating device, an information generating method, and an information generating program.

### BACKGROUND

A system for visually expressing a processing result of software (a program) with respect to a certain setting condition is used as a tool for supporting a software test. For example, a system displaying a timeline depicting activity levels during the execution of a program is proposed.

### BRIEF DESCRIPTION OF THE DRAWINGS

FIG. 1 is a diagram exemplifying a functional configuration of an information generating system according to a first embodiment;

FIG. 2 is a diagram exemplifying a hardware configuration of the information generating system;

FIG. 3 is a diagram exemplifying internal configurations of an information processing terminal and a server;

FIG. 4 is a diagram exemplifying aggregated records;

FIGS. 5A to 5E are diagrams exemplifying a display image according to the first embodiment;

FIGS. 6A and 6B are diagrams exemplifying the display image according to the first embodiment;

FIG. 7 is a flowchart exemplifying a flow of processing of the information generating system according to the first embodiment;

FIG. 8 is a flowchart exemplifying the flow of the processing of the information generating system according to the first embodiment;

FIG. 9 is a diagram exemplifying a display image according to Modification 1 of the first embodiment;

FIG. 10 is a diagram exemplifying functional configuration of an information generating system according to a second embodiment;

FIGS. 11A and 11B are diagrams exemplifying a display image according to the second embodiment; and

FIG. 12 is a flowchart exemplifying a flow of processing of the information generating system according to the second embodiment.

### DETAILED DESCRIPTION

### First Embodiment

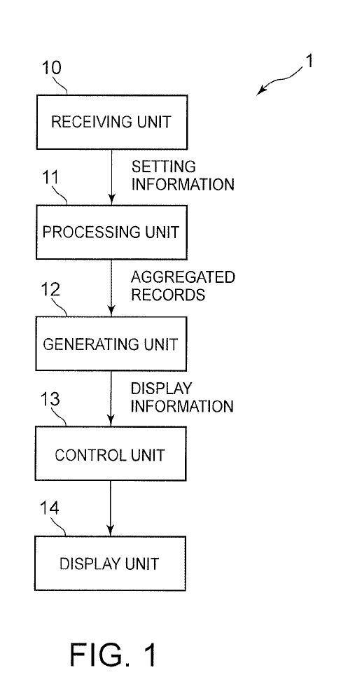

FIG. 1 is a diagram exemplifying a functional configuration of an information generating system 1 according to a first embodiment. The information generating system 1 is a system generating information relevant to the processing of a target module.

The target module is a module outputting a certain processing result with respect to a certain setting condition, and for example, is hardware executing predetermined arithmetic processing by an integrated circuit (IC), software (a program) controlling a processor, and the like.

For example, test processing is assumed as the processing of the target module. The test processing is processing of acquiring information for determining whether or not the target module suitably performs the processing. According to the test processing, a correspondence relationship between setting conditions and a processing result is acquired. The setting conditions are information relevant to the configuration or the like of the target module. In a case where the target module is hardware, for example, the number of cores, the capacity of memories, an operation frequency of the core, and the like can be the setting conditions. In a case where the target module is software, for example, the number of threads, the number of execution options, and the like can be the setting conditions. The processing result is information representing the result of the execution or the simulation of the target module. In a case where the target module is hardware, for example, an output value (an arithmetic result) according to the execution or the simulation, power consumption, the number of memory accesses, an execution performance value, and the like can be the processing result. In a case where the target module is software, for example, the output value according to the execution or the simulation, the execution performance value, and the like can be the processing result. The test processing is executed a plurality of times by changing the setting conditions, and thus, a plurality of correspondence relationships can be acquired. A specific method for executing the test processing is not particularly limited, and a known performance test and a method used for a function test or the like can be used. Furthermore, the processing of the target module is not limited to the test processing, and for example, may be the processing of the target module in normal times. In the following embodiments, a case will be described in which the processing of the target module is the test processing.

The information generating system 1 includes a receiving unit 10, a processing unit 11, a generating unit 12, a control unit 13, and a display unit 14.

The receiving unit 10 acquires a combination of a plurality of setting conditions from a user. Hereinafter, the combination of the setting conditions will be referred to as setting information. For example, the user inputs the combination of the plurality of setting conditions by using a user interface such as a keyboard or a mouse.

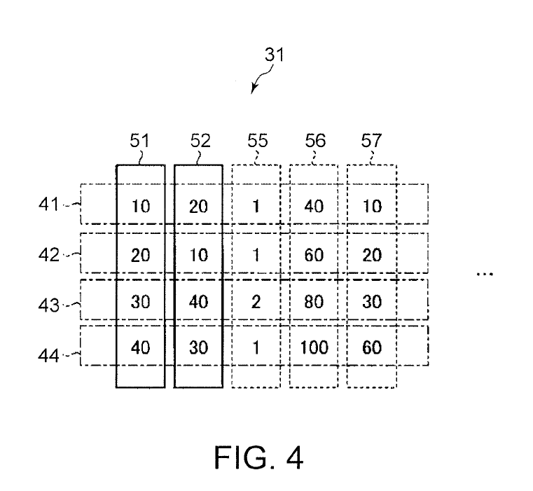

The processing unit 11 executes the test processing by using the setting information acquired by the receiving unit 10. Then, aggregated records representing the correspondence relationship between the setting conditions and the processing result for each test processing are acquired. The aggregated records will be described below in detail by FIG. 4 or the like. The processing unit 11, for example, is configured of a central processing unit (CPU), a program controlling the CPU, a logic circuit, and the like.

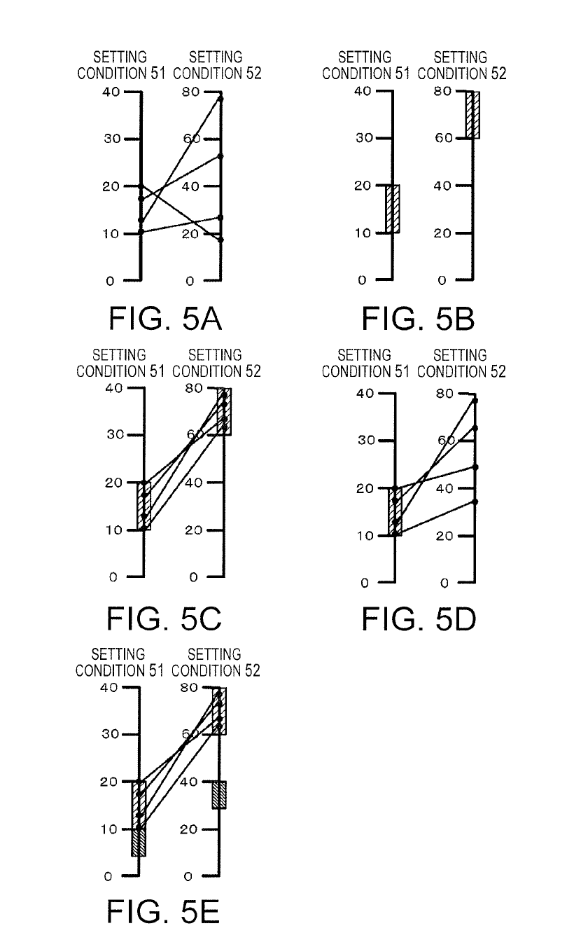

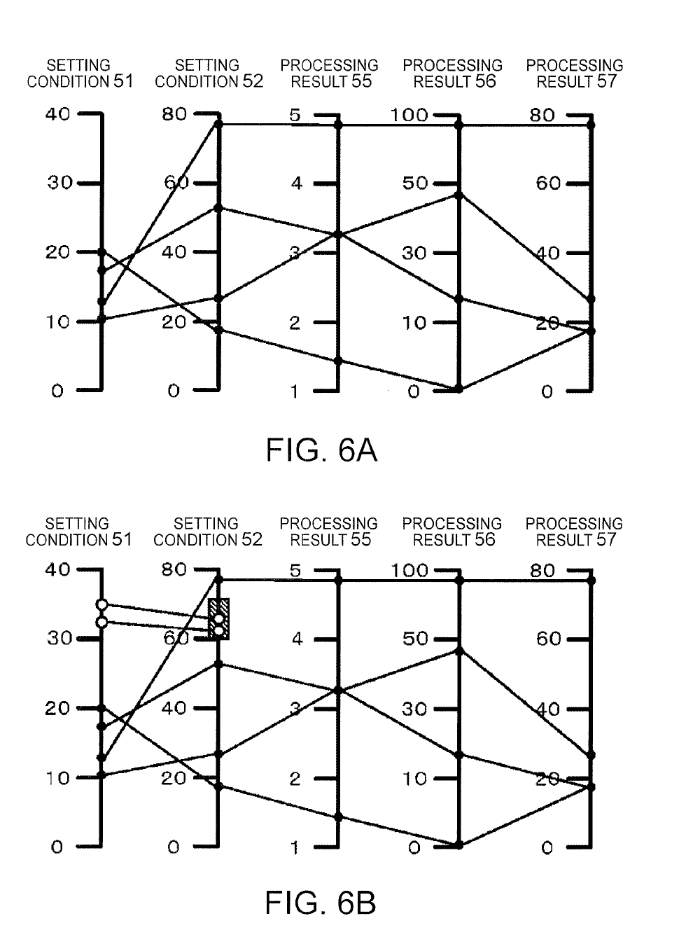

The generating unit 12 generates display information for generating a display image which visually expresses the correspondence relationship for each test processing, on the basis of the aggregated records. The display image will be described below in detail by using FIGS. 5A to 5E, FIGS. 6A and 6B, or the like. The generating unit 12, for example, is configured of a CPU, a program controlling the CPU, a logic circuit, and the like.

The control unit 13 controls the display unit 14 such that the display image is displayed, on the basis of the display information generated by the generating unit 12. The control unit 13, for example, is configured of a CPU, a program controlling the CPU, a logic circuit, and the like. The display unit 14, for example, is a display.

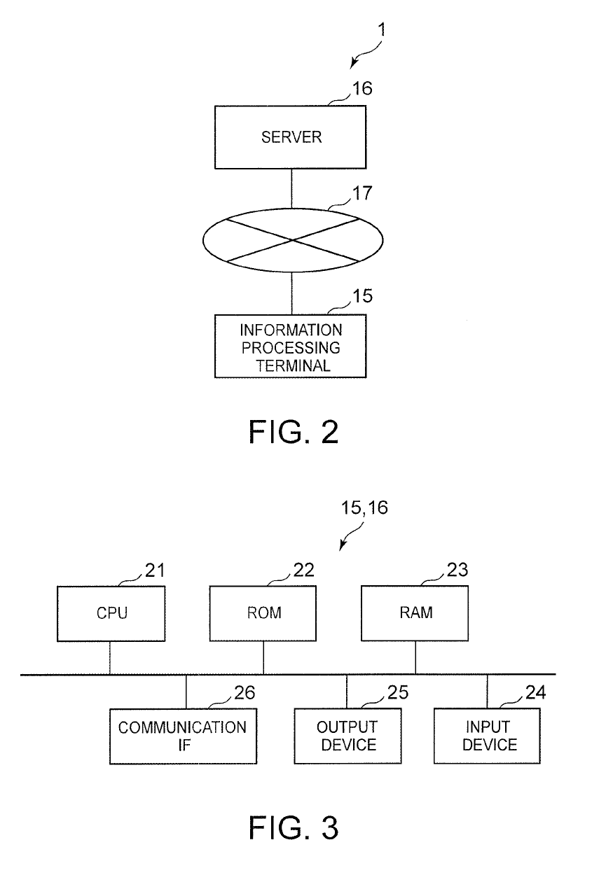

FIG. 2 is a diagram exemplifying a hardware configuration of the information generating system 1. The information generating system 1 includes an information processing terminal 15, a server 16, and a network 17. The information processing terminal 15 is a personal computer (PC), a tablet, a smart phone, or the like, which is used by the user. The server 16 is a server computer or the like, which is managed by a manager of the information generating system 1. The information processing terminal 15 and the server 16 are connected to each other through a network 17 such as the internet. It is preferable that the server 16 configures at least a part of the processing unit 11 and the generating unit 12 (executes at least a part of the processing for generating the display information). In addition, it is preferable that the display unit 14 displaying the display image is a display of the information processing terminal 15. In addition, it is preferable that the receiving unit 10 is realized by the information processing terminal 15.

FIG. 3 is a diagram exemplifying internal configurations of the information processing terminal 15 and the server 16. The information processing terminal 15 and the server 16 include a CPU 21, a read only memory (ROM) 22, a random access memory (RAM) 23, an input device 24, an output device 25, and a communication interface (IF) 26. The CPU 21 performs predetermined arithmetic processing by using the RAM 23 as a working area, according to a program stored in the ROM 22 or the like. The input device 24 is a device for inputting information from the outside, and for example, is a keyboard, a mouse, a touch panel, or the like. The output device 25 is a device for outputting information generated in the inside to the outside, and for example, is a display, a printer, or the like. The communication IF 26 is a device of enabling the information to be transmitted and received with respect to an external device through the network 17.

Furthermore, the hardware configuration illustrated in FIG. 2 and FIG. 3 is an example, and the information generating system 1 can be realized by various hardware configurations. For example, the receiving unit 10, the processing unit 11, the generating unit 12, the control unit 13, and the display unit 14, described above, can be realized by a single general-purpose computer, a dedicated device incorporated with a processor, or the like.

In addition, the receiving unit 10, the processing unit 11, the generating unit 12, the control unit 13, and the display unit 14, described above, can be realized by connecting a plurality of computers to each other through the intranet. For example, the server 16 and a plurality of information processing terminals 15 may be connected to each other through the network 17, and the receiving unit 10 may be realized by the plurality of information processing terminals 15.

In addition, FIG. 1 illustrates a configuration in which the receiving unit 10, the processing unit 11, the generating unit 12, the control unit 13, and the display unit 14 are connected to each other in the sequence of the processing, which are the most basic functional blocks of the information generating system 1, but the embodiment is not limited thereto. For example, a configuration in which the respective functional blocks perform an operation in parallel while cooperating with each other, a configuration in which the sequences of the functional blocks are exchanged with each other, a configuration in which one functional block is divided into a plurality of functional blocks, a configuration in which three configurations described above are combined with each other, and the like may be provided.

A program allowing the function of the information generating system 1 to be realized can be provided by being recorded in a recording medium readable by a computer, such as a CD-ROM, a flexible disk unit (FD), a CD-R, and a DVD, in a file of an installable format or an executable format. In addition, the program may be provided by being downloaded on a predetermined computer from a predetermined store device connected to a network, or may be provided in a predetermined information processing device by being incorporated in advance in a ROM or the like. In addition, the program may be configured of a plurality of modules realizing the functions of the receiving unit 10, the processing unit 11, the generating unit 12, the control unit 13, and the display unit 14, described above.

In addition, each of the functions of the receiving unit 10, the processing unit 11, the generating unit 12, the control unit 13, and the display unit 14, described above, may be realized by allowing the CPU 21 to execute the program, may be realized according to the function of the hardware such as an IC, and may be realized according to a combination thereof.

FIG. 4 is a diagram exemplifying aggregated records 31. The aggregated records 31 according to this example include a first record 41, a second record 42, a third record 43, and a fourth record 44. Each of the records 41 to 44 represents a correspondence relationship between setting conditions 51 and 52 and processing results 55 to 57 in one test processing. Each of the records 41 to 44 according to this example includes the first setting condition 51, the second setting condition 52, the first processing result 55, the second processing result 56, and the third processing result 57. That is, in this example, in one test processing, three types of the processing results 55 to 57 are obtained with respect to the input of two types of the setting conditions 51 and 52.

The setting conditions 51 and 52 and the processing results 55 to 57 are divided for each type. For example, a case will be considered in which the type of the first setting condition 51 is the “number of cores”, and the type of the second setting condition 52 is the “capacity of memories”. In this case, in the first record 41, a specific value of the first setting condition 51 (the number of cores) is “10”, and a specific value of the second setting condition 52 (the capacity of memories) is “20”. In addition, a case will be considered in which the type of the first processing result 55 is an “output value”, the type of the second processing result 56 is “power consumption”, and the type of the third processing result 57 is the “number of memory accesses”. In this case, in the first record 41, a specific value of the first processing result 55 (the output value) is “1”, a specific value of the second processing result 56 (the power consumption) is “40”, and a specific value of the third processing result 57 (the number of memory accesses) is “10”. Furthermore, the specific values are not limited to numerical values, and for example, may be characters, symbols, or the like.

FIGS. 5A to 5E are diagrams illustrating examples of a display image. In this embodiment, for example, selection conditions are displayed by using a parallel coordinate plot chart. In a case where the receiving unit 10 receives setting information of the setting condition 51 and the setting condition 52, as illustrated in FIG. 5A, an object representing the received setting information is displayed. For example, in a case where the setting information of “the setting condition 51 is 20, and the setting condition 52 is 18” is received, in FIG. 5A, black circles are illustrated by being plotted in a position of 20 on a coordinate axis representing the setting condition 51 and in a position of 18 on a coordinate axis representing the setting condition 52. Further, a line representing a relationship between the setting condition 51 and the setting condition 52 is displayed. Hereinafter, a line connecting the coordinate axes will be referred to as a relational object.

Furthermore, in the description using FIGS. 5A to 5E, a case where the setting conditions are represented by the numerical values is described as an example, and the setting conditions may be represented by values other than the numerical values. For example, the setting conditions may be represented by characters or symbols.

The receiving unit 10 may receive the input of the setting information representing the range of the setting condition 51 and the setting condition 52. For example, in a case where the setting information of “the setting condition 51 is 10 to 20, and the setting condition 52 is 60 to 80” is received, as illustrated in FIG. 5B, an object representing the range of the setting condition 51 and the setting condition 52 may be displayed on the coordinate axis.

In a case where the setting information is designated by the range, the processing unit 11 may extract all combinations between the setting condition 51 and the setting condition 52, which are designated by the range, and may execute the test processing in all of the combinations of the setting conditions. The processing unit 11 may randomly extract a predetermined number of combinations from all of the combinations between the setting condition 51 and the setting condition 52, which are designated by the range, and may execute the test processing. For example, as illustrated in FIG. 5C, both of the object representing the range of the setting information and the relational object representing the combination of the setting conditions, which is randomly extracted and is subjected to the test processing by the processing unit 11, may be displayed.

One setting condition may be designated by the range, and the other setting condition may be designated by a specific value. For example, in a case where the setting condition 51 is designated by the range, and the setting condition 52 is designated by the specific value, as illustrated in FIG. 5D, the object representing the range of the setting condition 51 and an object representing the value of the setting condition 52 are displayed. In this case, the processing unit 11 executes the test processing by using all combinations between a value included in the designated range of the setting condition 51 and the designated value of the setting condition 52, or a part of the combinations.

Display images illustrated in FIGS. 5A to 5E may be displayed not only after the test processing is executed by the processing unit 11 but also before the test processing is executed. For example, when the receiving unit 10 receives the setting information, the display images as illustrated in FIGS. 5A to 5E may be displayed on the basis of the received setting information.

An object at the time of displaying setting information which has been executed by the processing unit 11 and an object at the time of displaying setting information which is received by the receiving unit 10 as the setting information but has not been subjected to the test processing by the processing unit 11 yet may be displayed by changing a display format such as a color or a form. An example of a display image in the case of displaying both of the setting information which has been executed and the setting information which has not been executed yet is illustrated in FIG. 5E. For example, it is considered that the display image as illustrated in FIG. 5E is displayed when the processing unit 11 performs the test processing on the basis of the first setting information received by the receiving unit 10, and the receiving unit 10 receives the second setting information. In the example of FIG. 5E, a case is described in which the first setting information received and the second setting information received are designated by the range. However, for example, the first setting information may be designated by the range, and the second setting information may be designated by the specific value, or vice versa. In addition, for example, the first setting information, which has been designated, may be designated by a combination between the range and the specific value such that “the setting condition 51 is 20 to 30, 45, and 52, and the setting condition 52 is 18”.

Furthermore, the ranges of the axes displaying the setting conditions may be different according to the setting conditions. For example, in FIGS. 5A to 5E, the axis of the setting condition 51 represents a range of 0 to 40. On the other hand, the axis of the setting condition 52 represents a range of 0 to 80. In the setting conditions of the target module of the test processing, there is a range to be settable. For example, in a case where the setting condition 51 is the operation frequency of the core, there are the lower limit and the upper limit in the operation frequency to be settable. Hereinafter, information representing the range of the setting condition to be settable will be referred to as setting condition range information. The setting condition range information may be stored in advance, and the ranges of the axes of the setting conditions may be determined on the basis of the information. Accordingly, it is possible for the user to easily grasp the ranges of the selection conditions to be settable. In a case where the target module of the test processing is changed, the setting condition range information is also changed, and thus, it is possible to display the setting condition corresponding to the target module.

As described above, the receiving unit 10 displays the received setting information, and thus, the user is capable of selecting the setting conditions used for the next test processing while confirming the setting conditions which has been set. For this reason, it is possible to suitably select the setting conditions.

FIGS. 6A and 6B are diagrams illustrating other examples of the display image. FIGS. 6A and 6B are display images displaying not only the setting conditions but also the processing results. FIG. 6A is an example of a display image in a case where the setting condition 51 and the setting condition 52 are designated by the specific value. The generating unit 12 generates display information to display an object plotting the setting conditions and the processing results of each of the records included in the aggregated records on the axes, and a relational object connecting the setting conditions and the processing results.

Furthermore, as described above by using FIGS. 5B to 5D, the setting conditions may be designated by the range, or may be designated by the combination between the range and the specific value. In addition, as described above by using FIG. 5E, the setting information which has not been subjected to the test processing yet may be displayed together. In this case, an example of the display image is illustrated in FIG. 6B. FIG. 6B is an example of a display image to be displayed when the receiving unit 10 receives the second setting information. In this example, a case is described in which the setting condition 51 is designated by the specific value, and the setting condition 52 is designated by the range, as the second setting information. The first setting condition received as the specific value is represented by a black circle, the second setting condition received as the specific value is represented by a white circle, and a setting condition received as the range is represented by a hatched line. Further, in the example of FIG. 6B, the value of the setting condition 52 is randomly set from the range of the designated setting condition 52, and an object representing the value is represented by a white circle.

In the setting information which has not been subjected to the test processing yet does not include the processing result, and thus, the object representing the setting condition and the relational object connecting the setting conditions are displayed, but the corresponding processing result is not displayed. In contrast, in the setting information which has been subjected to the test processing, the corresponding processing result is also displayed.

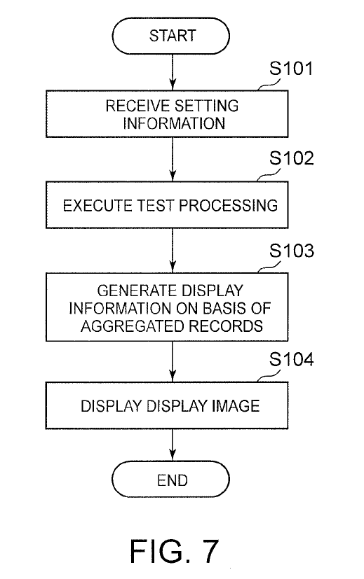

FIG. 7 is a flowchart illustrating an example of the processing of the information generating system 1 according to this embodiment. In Step S101, the receiving unit 10 receives the setting information. The receiving unit 10 is capable of receiving the input of the setting information of the setting condition 51 and the setting condition 52 by a keyboard. The coordinate axes of the setting conditions may be displayed before Step S101. In this case, the receiving unit 10 may acquire the setting information by receiving an operation to be clicked with a mouse or the like on the coordinate axes of the setting conditions displayed on the display unit 14.

In Step S102, the processing unit 11 executes the test processing on the basis of the setting information. In a case where the setting information is designated by the range, a predetermined number of combinations may be randomly extracted from all of the combinations of the setting condition 51, and the test processing may be executed. The result of the test processing is output as the aggregated records.

In Step S103, the generating unit 12 generates the display information on the basis of the aggregated records, and in Step S104, the control unit 13 controls the display unit 14 such that display based on the display information is performed. The process is returned to Step S101 after Step S104, and the setting information may be further received.

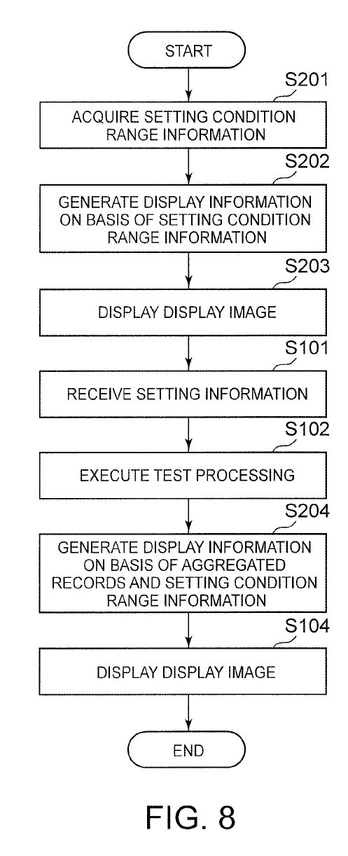

FIG. 8 is a flowchart illustrating another example of the processing of the information generating system 1 according to this embodiment. FIG. 8 illustrates processing in a case where a setting condition axis is displayed on the basis of the setting condition range information.

In Step S201, the generating unit 12 acquires the setting condition range information. Information set in advance according to the module of the test processing may read out as the setting condition range information, or the setting condition range information may be acquired through the communication with other devices.

In Step S202, the generating unit 12 generates the display information on the basis of the setting condition range information, and in Step S203, the control unit 13 controls the display unit 14 such that the display based on the display information is performed. Accordingly, it is possible for the user to view the range of the setting conditions to be settable.

Step S101 and Step S102 are identical to Steps S101 and S102 of the processing illustrated in FIG. 7.

In Step S204, the generating unit generates the display information on the basis of the aggregated records and the setting condition range information, and in Step S104, the control unit 13 controls the display unit 14 such that the display based on the display information is performed. The process is returned to Step S101 after Step S104, and the setting information may be further received.

(Modification 1)

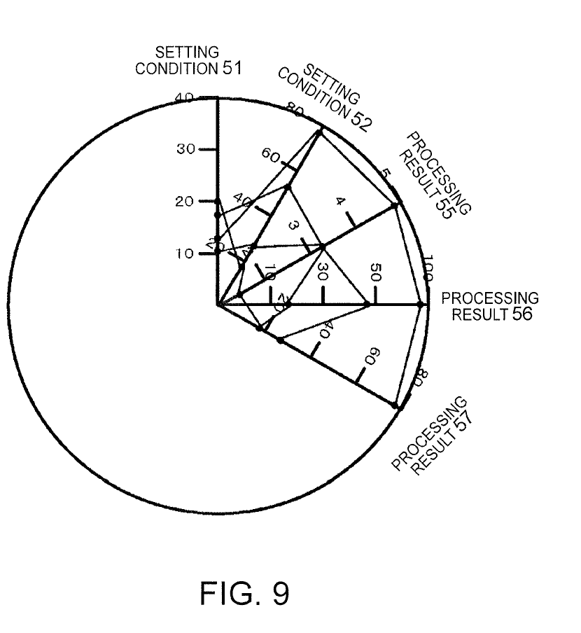

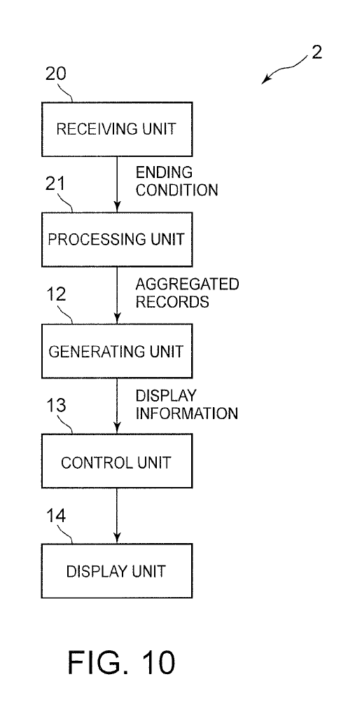

In FIGS. 5A to 5D and FIGS. 6A and 6B, an example has been described in which the display image is displayed as the parallel coordinate plot chart, but the display image is not limited to be displayed as the parallel coordinate plot chart. As illustrated in FIG. 9, the display image may be displayed as a radar chart. A display image may be used in which an axis corresponding to the setting condition and an axis corresponding to the processing result are displayed, and the relational object representing the relationship between the setting condition and the processing result is displayed.

### Second Embodiment

In the first embodiment, the information generating system receiving the designation of the setting condition has been described. In a second embodiment, an information generating system receiving the designation of the processing result will be described. A hardware configuration of an information generating system 2 according to the second embodiment, or internal configurations of a server and an information processing terminal are identical to those of the information generating system 1, and thus, the description will be omitted.

The information generating system 2 according to the second embodiment includes a receiving unit 101, a processing unit 102, a generating unit 12, a control unit 13, and a display unit 14. The generating unit 12, the control unit 13, and the display unit 14 are identical to those of the information generating system 1, and thus, the description will be omitted.

The receiving unit 101 receives the specific value or the range of the processing result as ending conditions of the test processing. The receiving unit 101 may receive the input of the range of the processing result by a keyboard, or may receive the specific value or the range of the processing result by being clicked with a mouse or the like on the coordinate axis of the processing result displayed on the display unit 14.

The processing unit 102 repeats the test processing by changing the setting conditions until the processing result satisfying the ending conditions received by the receiving unit 101 is obtained, and generates the aggregated records. The setting conditions may be randomly set, may be set by using a known algorithm for optimization, or may be set by sequentially using the setting conditions of the predetermined range. In addition, as described in the first embodiment, the receiving unit 101 may receive the designation of the range or the specific value of the setting conditions from the user.

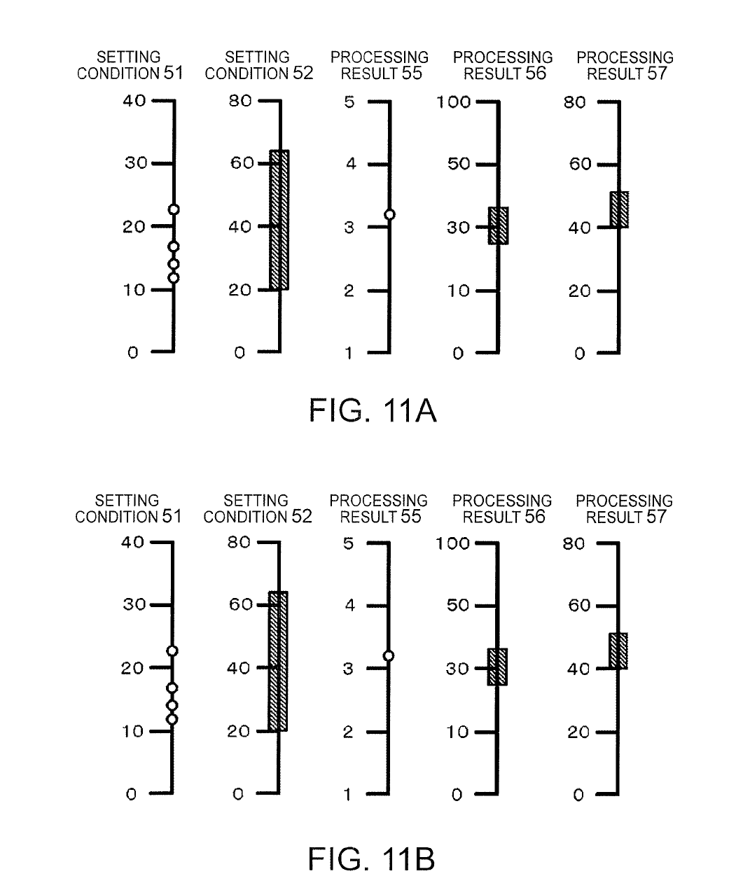

FIGS. 11A and 11B illustrate examples of the display image of the information generating system 2. For example, an example will be described in which the receiving unit 101 receives a combination of the setting conditions (the setting information) and a combination of the processing results (the ending conditions) from the user. FIG. 11A is an example of a display image to be displayed before the test processing is executed by the processing unit 102. FIG. 11B is an example of a display image to be displayed after the test processing. In FIG. 11A, a case is illustrated in which the setting condition 51 and the processing result 55 are designated by the specific value, and the setting condition 52, the processing result 56, and the processing result 57 are designated by the range.

As illustrated in FIG. 11B, the display image to be displayed after the test processing may be displayed in a display format which is different from a relational object connecting the setting information and the ending information satisfying the ending conditions, and the other relational object. In FIG. 11B, the relational object connecting the setting information and the ending information satisfying the ending conditions is illustrated by a solid line, and the other relational object is illustrated by broken line. According to such display, the user views which setting information and the setting information which has been set satisfy the ending conditions, and easily designates the setting information or the ending conditions to be set next. Furthermore, in the examples of FIGS. 11A and 11B, a case is illustrated in which both of the setting information and the ending conditions are designated, but only the ending conditions may be designated.

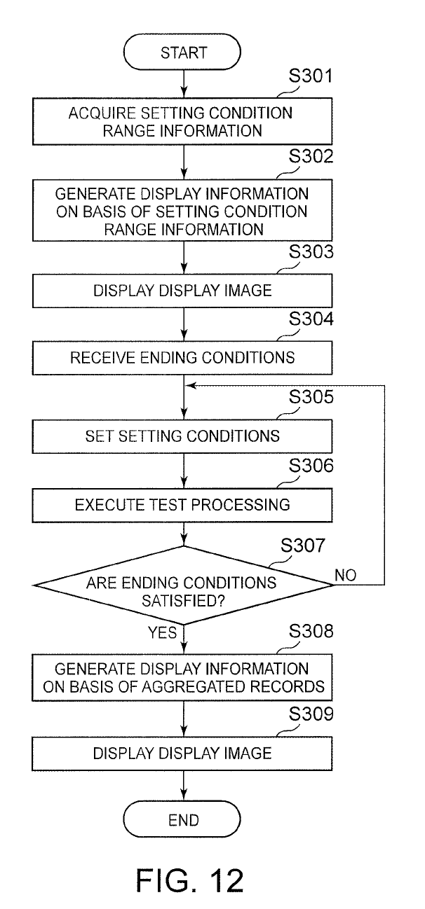

FIG. 12 illustrates a processing flowchart of the information generating system 2. In Step S301, the receiving unit 101 acquires the setting condition range information. Furthermore, information may be acquired in which an allowable range of the processing result is set. In Step S302, the processing unit 102 generates the display information on the basis of the setting condition range information of the generating unit. In a case where the range information of the processing result is set, the display information is generated such that the axis of the processing result is displayed on the basis of the range information of the processing result. In Step S303, the control unit 13 controls the display unit 14 such that the display image is displayed on the basis of the display information.

In Step S304, the receiving unit 101 receives the ending conditions. In Step S305, the processing unit 102 sets the setting conditions. In a case where the designation of the setting information is received from the user, the setting conditions are set by using the setting information. In Step S306, the processing unit 102 executes the test processing in the setting conditions which are set. In Step S307, the processing unit 102 determines whether or not the result of the test processing satisfies the ending conditions. In a case where the result of the test processing does not satisfy the ending conditions (No of S307), the process is returned to Step S305, and the test processing is repeated in new setting conditions. In a case where the result of the test processing satisfies the ending conditions (Yes of S307), in Step S308, the generating unit 12 generates the display information on the basis of the aggregated records, and in Step S309, the control unit 13 displays the display image on the basis of the display information by controlling the display unit 14.

Furthermore, the test processing may be repeated until the ending conditions are satisfied, or in a case where the test processing is repeated a predetermined number of times even though the ending conditions are not satisfied, the repetition may be ended. The predetermined number of times may be determined in advance, or the designation may be received from the user.

The second embodiment can be modified according to the modification or the like described in the first embodiment. As described in the modification of the first embodiment, the display image may be the radar chart.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information generating system generating display information representing setting conditions at the time of executing a target module outputting a processing result according to the setting conditions, the system comprising:
a receiver receiving the setting conditions selected by a user; and
a generator generating the display information for generating a display image,
wherein one or more setting condition axes representing the setting conditions are displayed on the display image, first value objects representing specific values of the setting conditions received in the receiver are displayed on the setting condition axes, and a relational object representing a correspondence relationship is displayed between the first value objects.

2. The information generating system according to claim 1, further comprising:
an acquirer acquiring the processing result obtained by executing processing of the target module on the basis of the setting conditions received in the receiver,
wherein one or more processing result axes representing the processing result are further displayed on the display image, a second value object representing a specific value of the processing result is displayed on the processing result axis, and the relational object is also displayed between the first value object and the second value object.

3. The information generating system according to claim 1,
wherein the acquire further acquires setting condition range information representing a range of enabling the setting conditions to be set, and
the setting condition axis displays a range of enabling the setting condition range information to be set.

4. The information generating system according to claim 1, further comprising:
a processor executing the processing of the target module by using the setting conditions received by the receiver,
wherein the receiver further receives the processing result selected by the user, and
the processor repeats the processing of the target module by changing the setting conditions until the processing result received by the receiver is satisfied.

5. The information generating system according to claim 1,
wherein the display image is a parallel coordinate plot chart.

6. The information generating system according to claim 1,
wherein the display image is a radar chart.

7. The information generating system according to claim 1, further comprising:
a information processing terminal used by the user; and
a server connected to the information processing terminal through a network,
wherein at least a part of processing for generating the display information is performed by the server, and the display image is displayed on a display of the information processing terminal.

8. An information generating device generating display information representing setting conditions at the time of executing a target module outputting a processing result according to the setting conditions, the device comprising:
a receiver receiving the setting conditions selected by a user;
a generator generating the display information for generating a display image; and
a display displaying the display image on the basis of the display information,
wherein one or more setting condition axes representing the setting conditions are displayed on the display image, first value objects representing specific values of the setting conditions received in the receiver are displayed on the setting condition axes, and a relational object representing a correspondence relationship is displayed between the first value objects.

9. An information generating method generating display information representing setting conditions at the time of executing a target module outputting a processing result according to the setting conditions by a computer, the method comprising:
a step of receiving the setting conditions selected by a user; and
a step of generating the display information for generating a display image,
wherein one or more setting condition axes representing the setting conditions are displayed on the display image, first value objects representing specific values of the setting conditions received in the receiver are displayed on the setting condition axes, and a relational object representing a correspondence relationship is displayed between the first value objects.

10. An information generating program product allowing a computer to generate display information representing setting conditions at the time of executing a target module outputting a processing result according to the setting conditions, the information generating program product, able to be stored on a non-transitory computer readable medium, allowing the computer to execute:
processing of receiving the setting conditions selected by a user; and
processing of generating the display information for generating a display image,
wherein one or more setting condition axes representing the setting conditions are displayed on the display image, first value objects representing specific values of the setting conditions received in the receiver are displayed on the setting condition axes, and a relational object representing a correspondence relationship is displayed between the first value objects.
